(19) United States
(12) Patent Application Publication
(10) Pub. No.: US 2006/0250328 A1
(43) Pub. Date: Nov. 9, 2006

(54) PLASMA DISPLAY APPARATUS

(75) Inventor: You Jin KWON, Gumi-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/279,837

(22) Filed: Apr. 14, 2006

(30) Foreign Application Priority Data
Apr. 15, 2005 (KR) 10-2005-0031469

(51) Int. Cl. G09G 3/28

(52) U.S. Cl. 345/60

(57) ABSTRACT

A plasma display apparatus according to the present invention includes a plurality of drivers connected to a first electrode of a panel, and a control board connected to at least one of the drivers. The control board receives an image signal and generates a control signal and an address signal according to the received image signal and applies directly the address signal to an address electrode. Thus, an address board for generating the address signal may be removed or the board size may be decreased. Therefore, the number of driving boards for driving the plasma display panel is reduced and the utilization of the space, to which the driving board is affixed, is enhanced and at the same time the size and number of the boards are reduced, thus reducing the manufacturing cost of the board.

### BACKGROUND OF THE INVENTION

1. Field of the Invention

The present invention relates to a plasma display apparatus, and more particularly, to a plasma display apparatus of which the manufacturing cost of a board can be reduced by enhancing the space utilization at the rear surface thereof and the noise of driving signals is prevented.

2. Description of the Conventional Art

FIG. 1 is a block diagram illustrating a construction of a conventional plasma display apparatus, and FIG. 2 illustrates a plurality of driving boards disposed on a panel rear surface of a conventional plasma display apparatus.

A plasma display apparatus is a display device in which gases within the panel are discharged to generate vacuum ultraviolet rays (VUV) and then light is emitted by colliding the VUV with phosphors within the panel.

Referring FIGS. 1 and 2, the plasma display apparatus includes a panel 6 having a discharge cell and an electrode for conducting the discharge, and a driving circuit board for driving the plasma display apparatus.

A frame 7 to function as a support for adhering the driving circuit board is formed on a rear surface of the panel 6. The circuit board for driving the plasma display apparatus includes fundamentally a control board 1 for generating control signals that receive an image signal and control the discharge of the plasma display apparatus, address boards 2a and 2b for generating address signals by the control signals generated in the control board, a scan board 3 for generating scan signals, and a sustain board 4 for generating sustain signals.

The address boards 2a and 2b, the scan board 3, and the sustain board 4 are connected to an address electrode, a scan electrode, and a sustain electrode through a plurality of drivers 5 to function as a gate that supplies signals applied to the address electrode, the scan electrode, and the sustain electrode.

Here, address signals, scan signals, and sustain signals that are generated in the control board 1 are respectively synchronized by a clock generated in the control board and then applied to the electrodes. If a data path, over which the address signals, the scan signals, and the sustain signals pass, becomes longer, a noise is carried to the address signal, the scan signal, and the sustain signal, thus deteriorating an image quality to be displayed.

Specially, in case of the scan signal and the sustain signal, an identical pulse signal is always alternatively applied and a surface discharge is generated according to the applied address signal, thus reducing a noise sensitivity. However, since the address signal is a signal for selecting a discharge cell, in which the discharge is generated according to the received image signal, the damage of the signal by the noise may cause not to generate the discharge in the cell, in which the discharge would be generated, or may generate the discharge in the cell, in which the discharge would not be generated, thus generating an erroneous discharge.

Generally, the control board 1 is located between the scan board 3 and the sustain board 4, and on an upper part of the address boards 2a and 2b. When the control signal generated in the control board 1 is applied to the address boards 2a and 2b, a transfer length of data is increased.

Further, since a length from the control board 1 to the address board 2a and 2b is long in the address electrode disposed outside the panel 6, the control signal carries much noises and thus it is difficult to generate the accurate address signal.

In order to prevent the difficulty, a plurality of buffers is used in the address boards 2a and 2b to remove the noise. When the size of the address boards 2a and 2b becomes larger and the number of the address boards 2a and 2b is increased, the number of the used buffer is increased. Thus, much manufacturing cost is required.

### SUMMARY OF THE INVENTION

The present invention is contrived to resolve problems of the conventional technology described above, and may provide a plasma display apparatus in which a space utilization of a rear surface thereof may be enhanced by decreasing or removing a size of an address board and the manufacturing cost of a board may be reduced and a noise of a driving signal may be mitigated.

A plasma display apparatus according to a first characteristic of the present invention may include a plurality of drivers connected to a first electrode of a panel, and a control board connected to at least one of the drivers.

A plasma display apparatus according to a second characteristic of the present invention may include a plurality of drivers connected to a first electrode of a panel, a control board connected to at least one of the drivers, and a first electrode driving board connected to the other drivers.

A plasma display apparatus according to a third characteristic of the present invention may include a plurality of drivers connected to a first electrode of a panel, and a control board connected to all the drivers.

A plasma display apparatus according to a fourth characteristic of the present invention may include a plurality of drivers connected to a first electrode of a panel, and a control board for applying a driving signal to the driver, and at one signal line connected to the driver and the control board.

### BRIEF DESCRIPTION OF THE DRAWINGS

FIG. 1 is a block diagram illustrating a construction of a conventional plasma display apparatus.

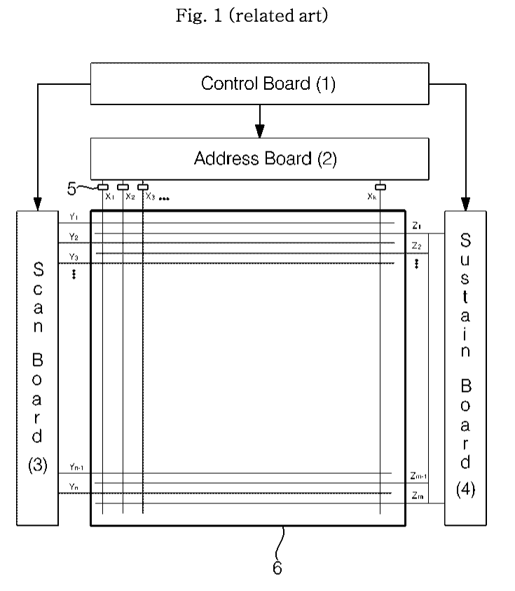

FIG. 2 illustrates a plurality of driving boards disposed on a rear surface of a panel of a conventional plasma display apparatus.

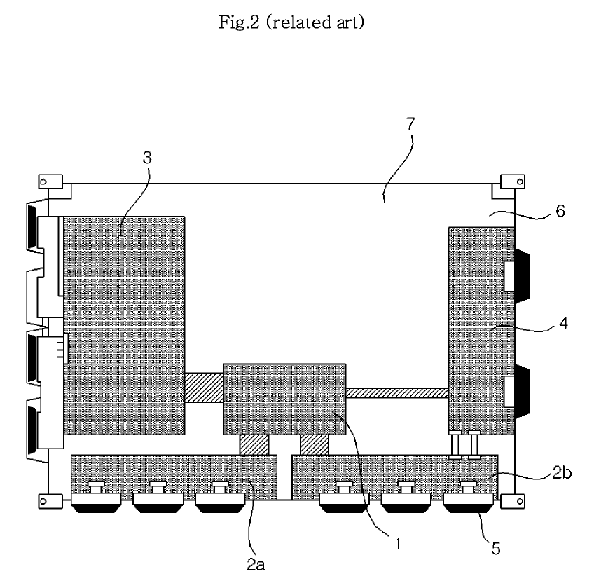

FIG. 3A is a block diagram illustrating a construction of a plasma display apparatus according to the first embodiment of the present invention.

FIG. 3B illustrates a plurality of drivers located on a rear surface of a panel of a plasma display apparatus according to the first embodiment of the present invention

FIG. 4A is a block diagram illustrating a construction of a plasma display apparatus according to the second embodiment of the present invention.

FIG. 4B illustrates a plurality of drivers located on a rear surface of a panel of a plasma display apparatus according to the second embodiment of the present invention.

FIG. 5A is a block diagram illustrating a construction of a plasma display apparatus according to the third embodiment of the present invention.

FIG. 5B illustrates a plurality of drivers located on a rear surface of a panel of a plasma display apparatus according to the third embodiment of the present invention.

FIG. 6 illustrates a plurality of drivers located on a rear surface of a panel of a plasma display apparatus according to the fourth embodiment of the present invention.

### DETAILED DESCRIPTION OF THE PREFERRED EMBODIMENT

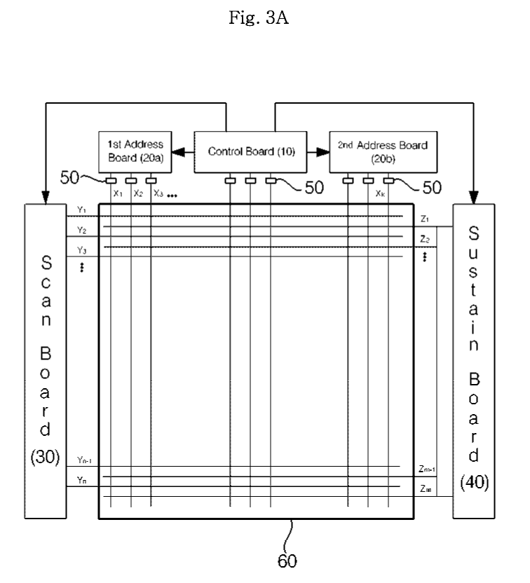

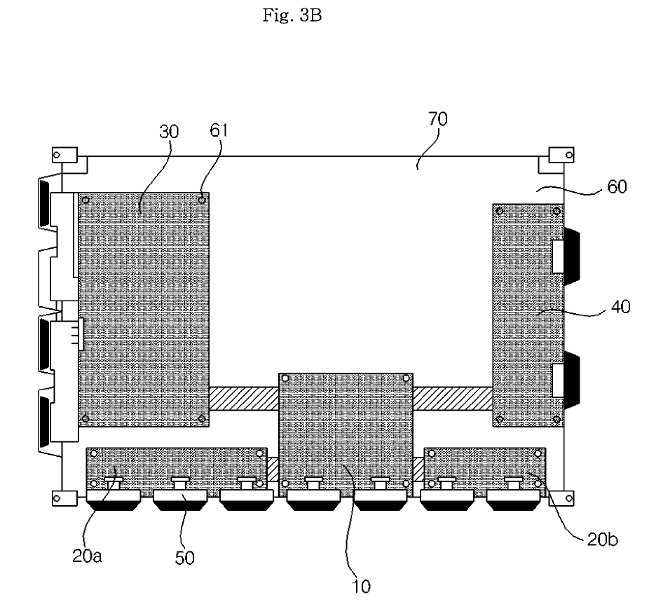

Hereinafter, a plasma display apparatus according to the present invention will be described with referenced to accompanying drawings. FIG. 3A is a block diagram illustrating a construction of a plasma display apparatus according to the first embodiment of the present invention, and FIG. 3B illustrates a plurality of driving boards disposed on a panel rear surface of a plasma display apparatus according to the first embodiment of the present invention.

The plasma display apparatus according to the present invention includes a panel 60 having a plurality of address electrodes X₁-Xₖ arranged in a row direction, and a plurality of scan electrodes Y₁-Yₙ and sustain electrodes Z₁-Zₘ arranged in a column direction and intersected with the address electrode. The scan electrode is formed by confronting with each sustain electrode, and one end of the sustain electrode is connected to one end of the scan electrode so as to apply the same voltage to them.

The panel 60 is manufactured by binding a front panel, on which the scan electrodes Y₁-Yₙ and the sustain electrodes Z₁-Zₘ are alternatively horizontally formed, and a rear panel, on which the address electrodes X₁-Xₖ is formed. The scan electrode and a common electrode and the address electrode are confronted and arranged across the discharge space between the electrodes so as to intersect vertically. The discharge space disposed on the intersection of the scan electrode and the common electrode and the address electrode forms one basic discharge cell.

Further, as the plasma display apparatus described above is shown in FIG. 3B, the plasma display apparatus includes a control board 10, in which a control signal is generated by analyzing and synchronizing R/G/B image signals in order to drive the panel 60 and display an image and then the address signal is generated and applied by some address electrode X₁-Xₖ.

A plasma display apparatus according to the first embodiment of the present invention further includes first and second address boards 20a and 20b (hereinafter, X board) for generating/applying an address signal by a control signal generated in the control board 10, a scan board 30(hereinafter, Y board) for generating a scan waveform applied to the scan electrodes Y₁-Yₙ, a sustain board 40(hereinafter, Z board) for generating a sustain waveform applied to the sustain electrodes Z₁-Zₘ.

The Y board 30 generates a sustain signal, a reset signal, and a scan voltage according to the control signal applied in the control board 10 and applies them to the scan electrodes Y₁-Yₙ.

The Z board 40 generates the sustain signal for generating a surface discharge according to the control signal applied in the control board 10 and applies it to the sustain electrodes Z₁-Zₘ.

The address electrode is divided into a predetermined number of groups. A driver 50 for dividing and applying the control signal to the relevant electrode is connected to one end of each address electrode group so as to drive a predetermined address electrode according to the address signal.

The driver 50 is connected to the control board 10 or the first and second address boards 20a and 20b. A plurality of drivers is formed on one end of the address electrode. That is, at least one driver 50 is connected to the control board 10.

It is the driver 50 that a driving IC to function as a gate of an address signal applied to the address electrode X₁-Xₖ is formed on a flexible printed circuit made of plastic material. For example, the driver is, but not limited to, a type of chip on film (COF), TCP, or FCOF.

That is, the driver 50 described above connects a plurality of electrodes and the control board 10 and the address board 20 which are formed on the panel 60, and functions as a connector to supply a driving signal generated in the control board to the panel.

Electric elements such as multi-chip-module (MCM) or ASIC chip, on which several chips for performing various functions on PCB circuit are integrated, are installed on the control board 10, and receive R/G/B image signals, and generate a control signal for applying a scan signal and a sustain signal in the Y board 30 and Z board 40.

Also, the control board 10 generates an address signal for generating an address discharge, and applies directly the signal to some of the address electrode X₁-Xₖ formed on the panel 60. The control board and the address electrode are connected by the driver 50 in order to apply the address signal to the predetermined address electrode according to the address signal.

The control board 10 includes a signal processing element for receiving R/G/B image data and generating the control signal so as to display an image in the plasma display apparatus, an alignment element for aligning data, and a clock adjustment element for controlling a clock of the control signal generated according to the R/G/B image signals. The clock adjustment element makes the clock of the generated control signal delayed so as to control timing of the address signal applied to the address electrode X₁-Xₖ.

Generally, as a length of pattern by which a signal goes becomes larger, a rising time of the signal is increased and the signal is distorted even by small noise. When an address signal is generated by controlling simply the timing of a clock in the control board described above and then directly applied to the driver 50 connected to the address electrode X₁-Xₖ, the length of the signal pattern by which the address signal goes is reduced and the signal distortion is decreased in case of some address electrodes, in which the address signal is directly applied from the control board.

Especially, as shown in FIGS. 3A and 3B, the control board 10 is directly connected to two or eight drivers, desirably two or three drivers 50 to apply directly an address signal to an address electrode X₁-Xₖ.

Drivers 50 for taking charge of the other address electrodes are connected to a first address board 20a and a second address board 20b. A control signal generated in the control board 10 goes by the first and second address boards and is applied to the address electrode through relevant driver.

The control board 10, as shown in FIG. 3B, is disposed in the middle of the first address board 20a and the second address board 20b so as to reduce a path of the control signal applied from the control board to the address electrode.

That is, the control board does not go by the address board but directly connects with some drivers. Since the directly connected driver receives directly the address signal from the control board, the signal path, in which the address signal transfers, is decreased. When the control board is disposed in the middle of the first address board and the second address board, the absolute length between the control board and the address electrode is decreased and a signal path, in which the address signal transfers, is more decreased upon a path heretofore in use, thus preventing a signal distortion due to the signal reduction and noise according to the increase of the path length.

When the control board 10 is directly connected to two or three drivers 50 to conduct some functions of the address board, the control board may be disposed between the first and second address boards and a space utilization at the rear surface of the plasma display apparatus may be enhanced. That is, the size of the address board is more decreased than that of the conventional address board, and the control board can be disposed on the space as much as reduced, thus enhancing the space utilization.

Further, since the control board is mounted between the first and second address boards so as to apply directly the address signal to some address electrodes in the control board 10, the size of the X board is more decreased than that of a conventional X board, and the signal distortion is prevented by reducing the length of the data path, by which the address signal goes within the X board, and also the number of the buffers used for preventing the signal reduction is more decreased than the number of conventional buffers, thus increasing the effect of cost-down.

The driving board is manufactured by designing a plurality of driving boards on a predetermined size of PCB. When the size of the address board is more decreased than that of the conventional address board, more address boards can be manufactured by using the same size of PCB, thus maximizing the effect of cost-down.

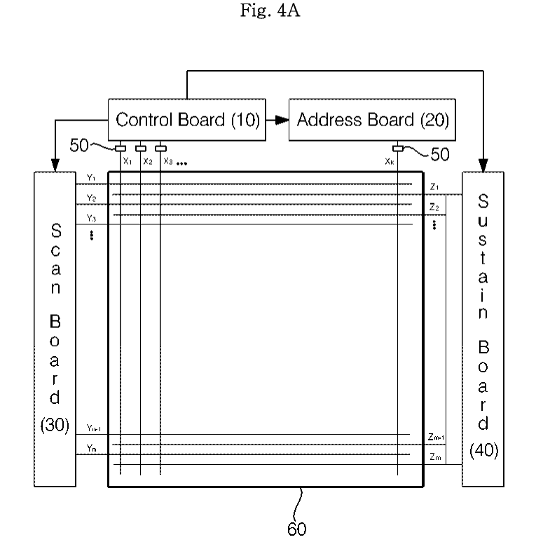

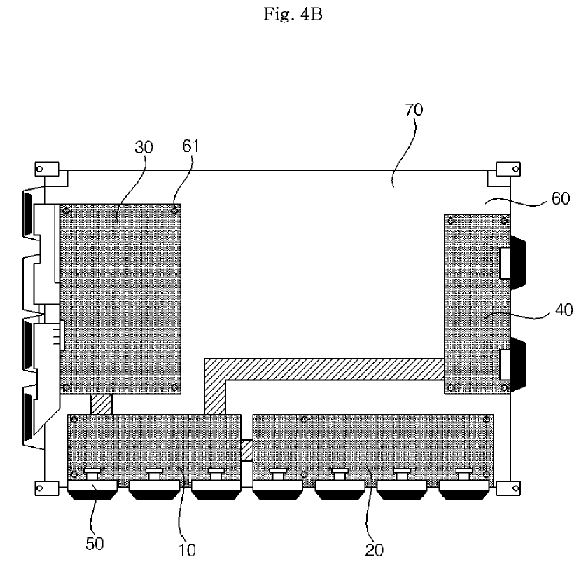

FIG. 4A is a block diagram illustrating the construction of a plasma display apparatus according to the second embodiment of the present invention, and FIG. 4B illustrates a plurality of drivers located on a rear surface of a panel of a plasma display apparatus according to the second embodiment of the present invention.

Referring to FIGS. 4A and 4B, in a plasma display apparatus according to the second embodiment of the present invention, a control board 10 is connected to at least one driver 50, and an address board 20 is connected to the other drivers 50.

That is, some drivers 50 are directly to the control board, and the other drivers are connected to one address board 20.

The construction of the second embodiment of the present invention is the same as that of the first embodiment of the present invention except that the use of one address board in the second embodiment is different from the first embodiment. In the second embodiment of the present invention, the control board 10 is connected to two or three drivers, which are located in order on the far left side of the drivers connected to the address electrodes, and the other drivers are connected to one address board.

Since the other construction of the second embodiment is the substantially same as the first embodiment, the explanation thereof will be omitted.

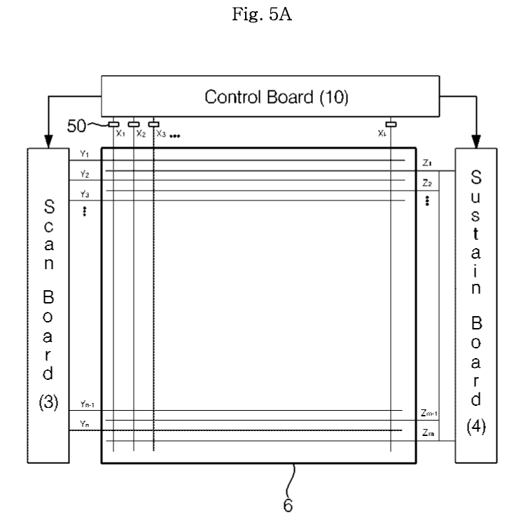

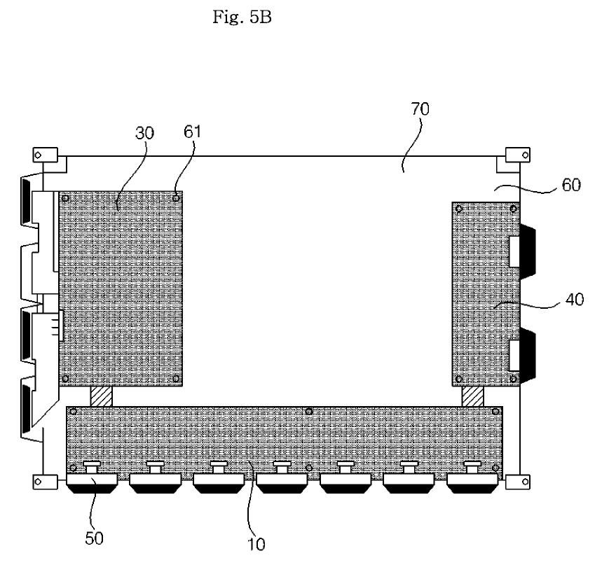

FIG. 5A is a block diagram illustrating the construction of a plasma display apparatus according to the third embodiment of the present invention, and FIG. 5B illustrates a plurality of drivers located on a rear surface of a panel of a plasma display apparatus according to the third embodiment of the present invention.

Referring to FIGS. 5A and 5B, in a plasma display apparatus according to the third embodiment of the present invention, a control board 10 is connected to all the drivers 50 without an address board. That is, the control board 10 conducts a function of the address board.

That is, the control board 10 is connected to all the drivers 50 at the same time and generates directly an address signal from received R/G/B image signals, thus incorporating with the address board.

Since the other construction of the third embodiment is the substantially same as the first embodiment, the explanation thereof will be omitted.

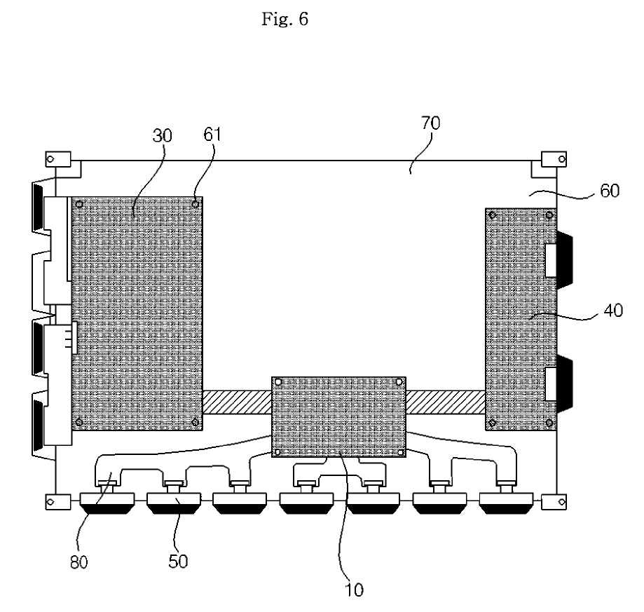

FIG. 6 illustrates a plurality of drivers mounted on a rear surface of a panel of a plasma display apparatus according to the fourth embodiment of the present invention.

Referring to FIG. 6, a block diagram of the apparatus construction in the fourth embodiment of the present invention is basically the same as in the third embodiment. However, the size of the control board 10 in the fourth embodiment is smaller than in the third embodiment. In the fourth embodiment, a plurality of drivers 50 is not directly connected to the control board 10 but to a flexible printed cable (hereinafter, FPC) 80.

That is, the fourth embodiment of the present invention is constructed so as to supply a data signal and a timing signal to the drivers 50 through the FPC. Accordingly, since signals are distributed to a plurality of drivers 50 through a flexible cable, the size of the control board 10 is more decreased in the fourth embodiment than in the third embodiment, in which the control board is directly connected to a plurality of drivers 50, thus reducing the manufacturing cost of the board.

At this time, a flexible flat cable (hereinafter, FFC) or conventional cable may be utilized instead of the FPC 80 to connect the control board 10 with the driver 50.

Since the other construction of the third embodiment is the substantially same as the first embodiment, the explanation thereof will be omitted.

As constructed above, a plasma display panel according to the present invention is constructed so that a control board receives an image signal and generates a control signal and an address signal according to the received image signal and applies directly the address signal to an address electrode. Thus, an address board for generating the address signal may be removed or the board size may be decreased. Therefore, the number of driving boards for driving the plasma display panel is reduced and the utilization of the space, to which the driving board is affixed, is enhanced and at the same time the size and number of the board are reduced, thus reducing the manufacturing cost of the board.

The invention being thus described, it will be obvious that the same may be varied in many ways. Such variations are not to be regarded as a departure from the spirit and essential characteristics of the invention and would be obvious to one skilled in the art. Therefore, the embodiments described above is exemplary but not limited to the present invention, and all such modifications as would be obvious to one skilled in the art are intended to be literally or equivalently included within the scope of the following claims.

What is claimed is:

1. A plasma display apparatus comprising:
a plurality of drivers connected to a first electrode of a panel; and
a control board connected to at least one of the drivers.

2. The plasma display apparatus as claimed in claim 1,
wherein the first electrode is an address electrode.

3. The plasma display apparatus as claimed in claim 1,
wherein the control board applies driving signals to the drivers.

4. The plasma display apparatus as claimed in claim 1,
wherein the drivers transfer driving signals applied from the control board to the first electrode.

5. The plasma display apparatus as claimed in claim 1,
wherein the drivers are comprised of at least one driving IC and a flexible printed circuit.

6. The plasma display apparatus as claimed in claim 5,
wherein the drivers are COF type (Chip on Film) or TCP (Tape Carrier Package).

7. The plasma display apparatus as claimed in claim 1,
wherein the control board is connected with two or eight drivers.

8. A plasma display apparatus comprising:
a plurality of drivers connected to a first electrode of a panel;
a control board connected to at least one of the drivers; and
a first electrode driving board connected to the other drivers.

9. The plasma display apparatus as claimed in claim 8,
wherein the first electrode is an address electrode.

10. The plasma display apparatus as claimed in claim 9,
wherein the first electrode driving board is an address electrode driving board.

11. The plasma display apparatus as claimed in claim 10,
wherein the first electrode driving board is composed of at least two sub-boards.

12. The plasma display apparatus as claimed in claim 11,
wherein the control board is positioned between at least two sub-boards.

13. The plasma display apparatus as claimed in claim 8,
wherein the control board is connected to two or three drivers.

14. A plasma display apparatus comprising:
a plurality of drivers connected to a first electrode of a panel;
a control board connected to the at least two drivers directly and connected to the others of said a plurality of drivers via at least one signal transfer line.

15. The plasma display apparatus as claimed in claim 14,
wherein the first electrode is an address electrode.

16. The plasma display apparatus as claimed in claim 14,
wherein the drivers are comprised of at least one of driving ICs and a flexible printed circuit made of plastic materials.

17. The plasma display apparatus as claimed in claim 14,
wherein the signal transfer line is a flexible flat cable or a flexible printed cable.
